(19) United States
(12) Patent Application Publication
(10) Pub. No.: US 2023/0148167 A1
(43) Pub. Date: May 11, 2023

(54) Drip ring for plant irrigation

(71) Applicant: Irritec S.p.A., Capo d'Orlando (ME) (IT)

(72) Inventor: Carmelo Giuffrè, Capo d'Orlando (ME) (IT)

(21) Appl. No.: 18/051,149

(22) Filed: Oct. 31, 2022

(30) Foreign Application Priority Data
Nov. 10, 2021 (IT) 102021000028538

(51) Int. Cl. A01G 25/02

(52) U.S. Cl. CPC A01G 25/02

(57) ABSTRACT

An irrigation device includes a hollow element having an at least partially closable opening and having a substantially open and optionally closable annular shape, one end of the hollow element having, at the opening, an outward radial extension to form a counter-curve defining a guiding section with a concavity different from the concavity of the remaining annular element. The device further includes a tubular element inserted or insertable in the hollow part of the annular element and provided with a plurality of openings to enable the dripping of a liquid when such liquid is introduced at one end of the tubular element, the opposite end being closed or closable with a plug or connectable to the first end with a connector.

### FIELD OF THE INVENTION

The present invention relates to a drip ring device for irrigating plants. In these devices, a hollow open ring container having many openings releases drops of water into the soil in which a plant is present to allow uniform watering. The container is commonly circular in shape such as an open ring consisting of two sectors branching off from a point of engagement: the opening allows the device to be positioned around the stem of the plant to be watered. The supply water reaches the two branches of the container via a coupling sleeve located centrally diametrically opposite the opening of the ring.

### BACKGROUND OF THE INVENTION

Devices of this type are known, for example, from documents US 2012/0080538A and US 2018/0103598A.

Although they fulfil their function very well, these known devices have some drawbacks.

First of all, the small holes in the bottom of the container tend to occlude. A solution is to keep the container raised off the ground using support feet. However, this does not prevent clogging due to limescale in the water.

In addition, to supply the device, a coupling sleeve must be provided in piece with the container and provided in a median position compared to two ring arcs. A supply pipe is to be connected to the coupling sleeve, which, if not correctly guided in the section close to the sleeve, may bend and restrict the flow of water or exert forces on the device which cause it to move out of the desired position or tilt with respect to the ground.

### SUMMARY OF THE INVENTION

The objective of the present invention is to provide a device for irrigating plants which at least partially solves the aforementioned drawbacks.

The invention achieves the scope with a device for irrigating plants comprising a channel element having a substantially open annular shape. Said annular shape is open circumferentially and is interrupted or interruptible at a point of the ring wherein the interruption defines two ring ends which are spaced apart or can be spaced apart forming an opening of said ring as said circumferentially; at least one of these ends has a radial extension outwardly to form a counter-curve defining a guiding section of a tubular element which is housed, preferably in a removable manner, in the channel of the channel element and this radial extension has a different concavity from the concavity of the remaining annular element. As mentioned above, the device further comprises a tubular element inserted or insertable into the channel, which tubular element is provided with a plurality of openings to allow a liquid to drip out when said liquid is injected at one end of the tubular element, the opposite end being closed or closable by means of a plug element; alternatively, when the device is realised in two or more segments which are relatively hinged so as to vary the width of the ring opening, the plugged end may be connected to the first end by means of a three-way connector from which water is drawn for distribution on the ground.

The guiding end of the annular element con-tributes to support the drip pipe or tubular element and may advantageously have a vertical coupling for the connection between the tubular element and a device supply pipe.

In an embodiment, the tubular element may be the end section of a more extensive tubing external to the device which supplies irrigation fluid to the tubular element of the device for the purpose of irrigating the vessel in which the device is positioned.

In an embodiment of the invention, the channel element is open at least one of the head sides at the two opposite ends of the open ring and one or more oscillating elements are provided for closing at least one of said two ends and/or at least one or more limited segments of the open side of the channel element, which oscillating elements are connected to one of the two walls which laterally delimit the channel element (e.g. in the case of oscillating elements closing one of the circumferential sections of the ring) or are connected to the back wall of the channel element (e.g. in the case of oscillating elements closing the duct near the end faces or circumferential ring break-off points) by means of a hinge and are swinging to the wall of the channel element opposite to that of said hinge, the end of the hinged oscillating elements and the co-operating wall of the channelled element being provided with co-operating means of mutual attachment in such a way that each oscillating element can be brought into an open position of the corresponding opening of the channelled element and alternatively into a closed position of the same in which it is optionally detachable. The two walls delimiting the side of the channel element may be referred to hereafter and for the sake of brevity as side walls.

The hinge is preferably of the film type obtained as a thinning of a section of the same material as the trough element and the oscillating element, the thinning being defined along a hinge axis.

When inserted into the annular element, the tubular element is placed with the closed or closable end at the end of the annular element opposite to the guiding end which advantageously may have a closing cap elastically constrained to the body of the annular element so that it can be rotated and positioned to close the tubular element. Said closing cap is preferably mounted or made of a piece on a said closing oscillating element of the end of the channel element in a position of the face of said oscillating element facing the inside of the channel element. In this way, the cap is bound to the central body of the device and is therefore not lost, and at the same time is easily inserted into the drip pipe (i.e. the tubular element) to close it. The provision of a tubular element within the ring element with coupling/closing elements associated with the same ring element allows for a simple structure that can be easily assembled/disassembled, e.g. for the replacement of the tubular element when certain irrigation holes are clogged.

In an embodiment, the guiding section comprises an overrun appendix to guide the tubular element along a path in a plane essentially orthogonal to the plane in which the said ring-shaped channel element extends. This feature, which can be freely realised in combination with one or more of the other features of the invention, is particularly advantageous in the use of the device in pots, where the presence of the pot edge, raised a few centimetres above the level of the soil inside the pot, is an obstacle in the known devices, or in installations, not necessarily in pots, where the supply pipe follows a path in a plane not coinciding with the plane in which the dripping device mainly develops. In known devices, the water supply pipe, external to the device, being usually rigid or only partially elastic, exerts an upward force on the device, lifting it partially or otherwise making its positioning less stable and/or leading to bending of the pipe that reduces the flow of water towards the device, making irrigation less efficient and unbalanced when there are several devices active at the same time on different plants. The presence of an overrun appendix at the end of the guiding section of the present invention solves this problem by providing the supply pipe with an engagement point for balancing the forces on the device and by accompanying the tubular element within the device itself so as to guide it as it passes over the pot border and prevents choking of the pipe or internal tubular element.

The presence of a guiding section on one side of the device then makes it possible to overcome the drawbacks due to the symmetry of construction of the known devices, as well as to facilitate the overrunning of the vessel rim for connection to a supply pipe.

In an embodiment, the annular element has a plurality of tubular element support elements which comprise removable closing elements of the annular element channel. In particular, the support elements for the tubular element can be mutually independent and stably connected to an edge of the annular element to be engageable/disengageable with the opposite edge of the annular element so as to form independent removable closing elements of the channel of the annular element.

This expedient also allows easy assembly/disassembly of the device.

In another embodiment, the annular element has a back wall and two U-shaped side walls, the supporting elements for the tubular element comprising L-shaped fins made of a piece with the annular element in the form of an extension of a side wall, the opposite side wall having corresponding extensions for elements which act as hooks to hold the fins in the closed position of the channel when each fin is brought into contact with the corresponding hook extension.

There may be support feet which can be inserted into the ground to be irrigated to hold the device firmly in position, for example by means of conical or truncated conical protuberances which can be detachably attached to the ring element.

The support feet can be advantageously attached to, or made of piece with, the support elements of the tubular element.

In a specific embodiment, the support feet protrude from the wall opposite the wall of the L-shaped fins designed to close the channel so that, when the free part of the fins is brought to engage the edge of the annular element, the feet are arranged substantially perpendicular to the annular element.

The back wall of the channel of the annular element may be closed or have openings, e.g. at the channel closure fins, to facilitate access from the outside to the tubular element.

In an alternative embodiment of the embodiment in which the device is realised as a set of mutually hinged circular arc-shaped segments, the swinging of said circular arc-shaped segments allows the reciprocal arrangement of said segments in such a way that the two ends of the channel element are substantially adjacent when the device is positioned in the closed working construction and the two ends of the tubular element are connected by means of a connecting element preferably in the form of a T-joint or elbow. In this way, it is possible to create a closed ring around the stem of the plant by positioning the open ring, the opening of which facilitates the passage of the segments around the stem and subsequently the closing of the ring, both of the channel and of the water-distributing tube, immediately before the device is placed on the ground. The water-carrying pipe or tubular element can then be connected to the two ends and to the supply pipe by means of elbow or three-way fittings which, in a further variant, are made in one piece or connected to the channel element, advantageously reducing the risk of loss of these small elements on site and in the post-production stages, and potentially improving production processes.

Further features and refinements are the subject of the dependent claims.

### BRIEF DESCRIPTION OF THE DRAWINGS

The features of the invention and the advantages derived from it will become more apparent from the following detailed description of the attached figures, wherein:

FIG. 1 shows an axonometric view of the lower part of the open ring channel element of a device according to an embodiment of the invention.

FIG. 2 shows the same view as the previous figure with a tubular element inserted into the channel element.

FIG. 3 shows the device of the preceding figures with fins supporting the tubular ring element in the closed position of the channel of the annular element.

FIG. 4 is a view of the upper part of the device of the preceding figure showing the openings on the back wall of the channel according to an embodiment of the invention.

FIGS. 5a, 5b, 5c represent line views of a form of the invention, with top, side and bottom views, respectively.

FIG. 5d is a detail enlargement of part of FIG. 5b.

FIG. 6 is a three-dimensional line view of the preceding figures.

FIG. 7 is a bottom view of a variant wherein the channel of the annular element is composed of two circular segments presented in a partially open position.

FIG. 8 shows a variant of the previous figure where the annular element channel is composed of three circular segments.

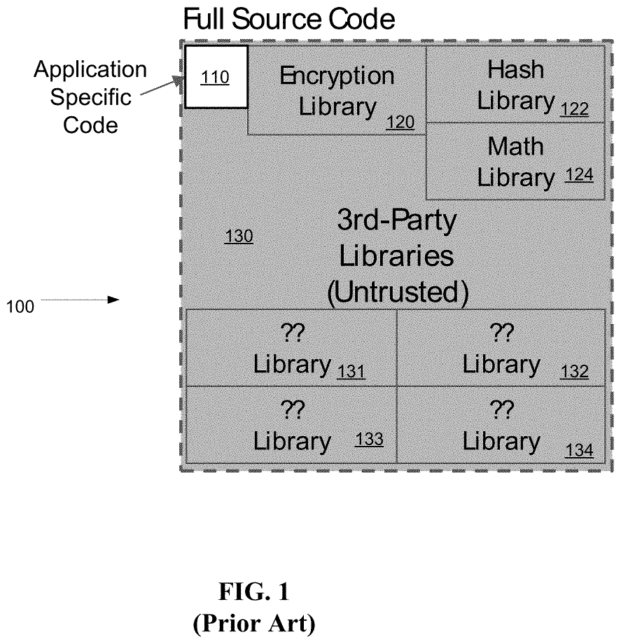

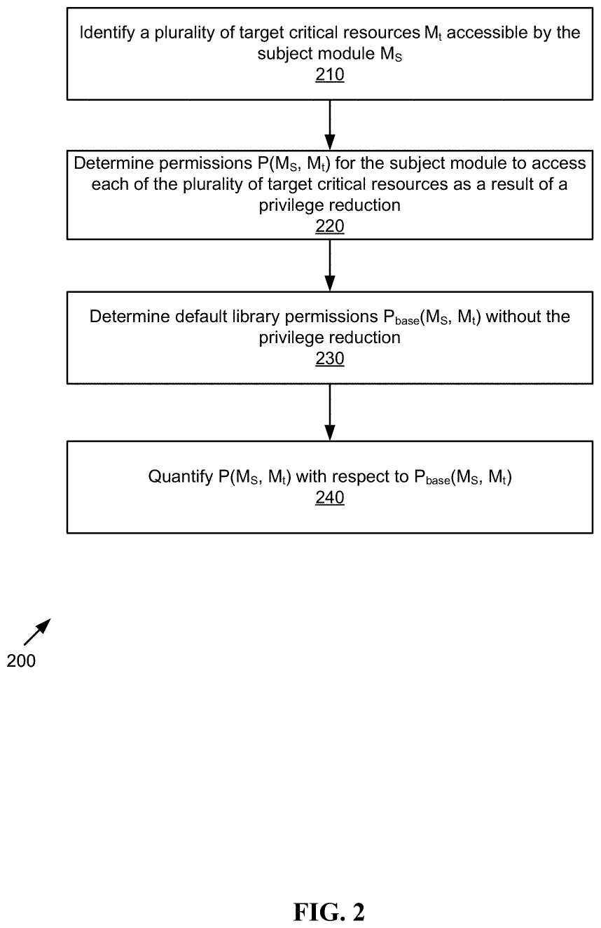

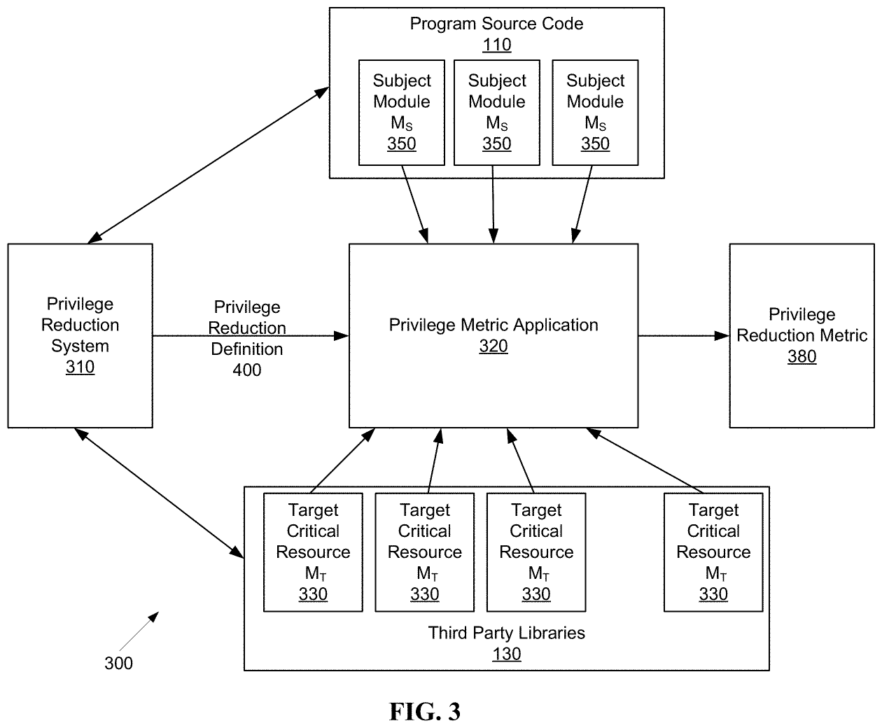

### DETAILED DESCRIPTION OF EMBODIMENTS OF THE INVENTION

With reference to the figures, the device according to an embodiment of the invention comprises a channel element 1 of substantially open annular shape. The channel element 1 comprises a flattened back wall 101 with perimeter side walls 201, 201′ parallel and arranged to form an open circular crown, i.e. without a circular sector (shown in hatched form in the figures) having a given angular extent.

The invention relates to a device for irrigating plants intended to be placed at the base of various types of plants comprising plants with woody stems of a given cross-section, which is partially or completely (in the case of the closed ring) surrounded at the base of the ground by the ring subject matter of the invention. The skilled person in art will have no difficulty in adapting the concepts expressed herein to similar shapes such as polygonal or elliptical shapes as an alternative to the circular shape described herein.

An open annular channel with a U-shaped cross-section such as that shown in the figures is the preferred form, although any configuration capable of providing a box-like element open on one side and arranged along a circumferential arc may be validly employed within the scope of the present invention. A further example may be a V-shaped configuration in which the perimeter walls are directly in contact with each other without interposition of the bottom element.

One end 301 of the channel element 1 at the opening has a radial extension outward to form a counter-curve 401 defining a guiding section with different concavity than the concavity of the remaining annular element. This prolongation 401 causes the channel element 1 to assume a profile approaching that of an interrogative point.

In an embodiment not shown by the figures, the guiding end 401 of the annular element 1 has a coupling element for connecting the end 103 of the tubular element 3 with a device supply tube (not shown in the figures). This coupling element can be made so as to be aligned with the end 103 of the tubular element (and therefore tangent to the irrigation ring at the point where the tubular element 3 ends) or made with an arched or V-bend shape preferably forming an angle of 90° so that the coupling can be oriented towards the external supply pipe according to a plurality of orientations freely settable during assembly of the irrigation ring. For example, the connector of the supply pipe could be oriented towards the centre of the ring or diametrically opposite or even vertically or obliquely to the ring extension plane. This facilitates the bypassing of any edge of the vessel to which the device is applied, or in general allows the supply pipe to be accompanied by the device connection, avoiding bending of the flexible elements and the consequent reduction of the water flow rate at the ground distribution openings.

The end 501 opposite the guiding end 401 of the annular element 1 has a closing cap 2 elastically constrained to the body of the annular element 1 so as to be rotatable and positioned to close a tubular element 3 which is inserted into the channel of the annular element 1 as shown in

The tubular element 3 is provided with a plurality of apertures to allow a liquid to drip out when said liquid is introduced at an end 103 of the tubular element 3.

The annular channel element 1 has a plurality of supporting elements 4 of the tubular element 3 which, in the specific example shown in the figures, are mutually independent and stably connected to an edge 201 of the annular element 1 to be engageable/disengageable with the opposite edge 201′ of the annular element 1 so as to form independent removable elements 4 of the channel closure.

In the specific embodiment shown in the Figures wherein the channel element 1 has a back wall 101 and two side walls 201, 201′ in the form of a U, the support elements for the tubular element 3 comprising L-shaped fins 41 made of piece with the annular element in the form of an extension of a side wall 201, the opposing side wall 201′ having corresponding extensions 601 for elements acting as a hook to hold the fins 41 in the closed position of the channel when each fin is brought to interfere with the corresponding hook extension.

The device according to the invention may advantageously comprise conical or truncated conical protuberances 5 attachable to the ring element 1 to form support feet suitable for being embedded in the soil to be irrigated to hold the device stably in position.

In the example shown in the figures, the support feet 5 protrude from the wall opposite the side of the L-shaped fins 41 which close the channel so that, when the free part of the fins is brought to engage on the edge of the annular element 201′, the feet 5 are arranged substantially perpendicularly to the annular element 1. In this way, by closing the fins, the fixing of the tubular element 3 and the positioning of the feet 5 in the operating mode is simultaneously ensured.

The annular element 1 may also advantageously have openings 6 on the bottom wall 101 of the channel to facilitate the assembly of the device and to allow visual inspection of the tubular element 3 during operation.

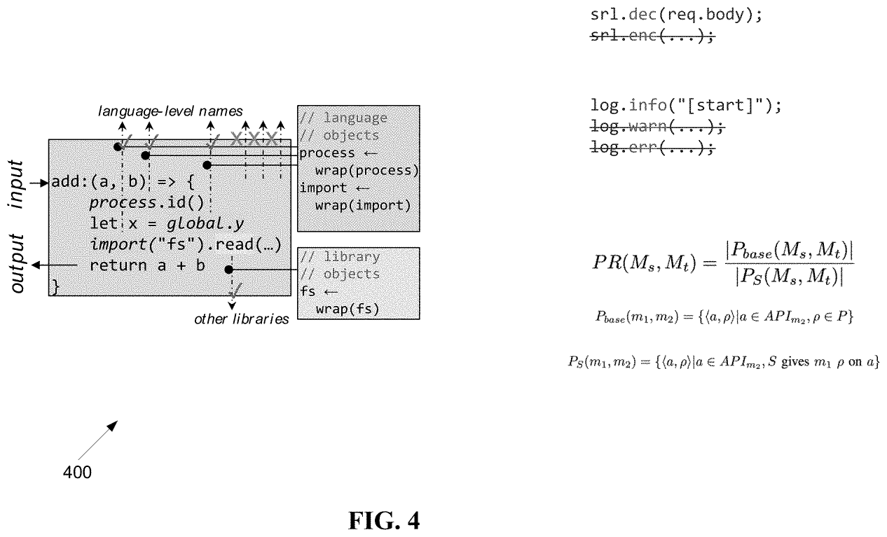

The view of FIG. 4 shows a configuration wherein the openings 6 are located at the supporting elements 4 closing the channel. Such openings can, of course, be positioned in any position and be of any number and size.

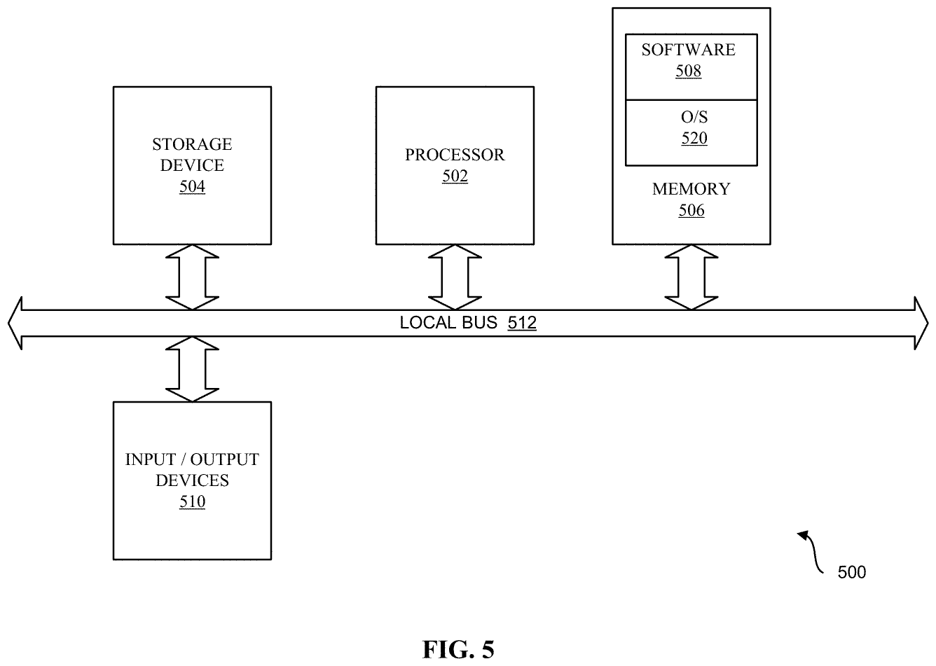

FIG. 5d shows an embodiment detail according to a variant wherein the feet have a central body of prismatic shape 50 on the surface of which are arranged gripping fins 502 oriented at an angle of less than 90° with respect to the vertical and intended to be inserted into the ground acting as retaining elements of the ring to the ground. In this embodiment, the central body 50 is hollow and has opposing openings intended to house a sheet of flexible material which, passing through the hollow body, gives rise to two retaining fins 502 and 502′.

FIG. 7 shows a further possible embodiment of the invention, which can be realised in any combination or sub-combination of the other constituent features, wherein the channel element 1 is realised as an assembly of two circular sectors 11, 12 connected in a zone of reciprocal engagement 202 which could be a hinge orthogonally arranged in the plane in which the channel body 1 is articulated; alternatively, similarly to some embodiments relating to the closure plug 2 and the support elements 4, it is possible that the two circular sectors 11 and 12 are interconnected along an elastic edge on the two opposing faces of said sectors.

The concept of the realisation of the channel body 1 in two sectors can be generalised to more than one sector, which may have similar or different angular openings as shown in FIG. 8, and it is in any case possible that the entire channel body 1 is realised in one piece and then partial cuts are subsequently made in the intrados areas 203 so as to segment the single body into two or more circular sectors. In this case, the various sections are hinged to each other by means of one or more film hinges 202 and 204 consisting in the wall or in a section of a predetermined length of the radially outer lateral wall of the channel profile which is not crossed by the cut.

A variant may provide for fastening elements in position of the various articulated segments of the channel element, which may be realised to the channel body 2 and the feet.

The feet may be realised as hook-like extensions fixed to one end of one of the two adjacent channel elements and anchorage housings of the opposite end realised angled or curved, such as one or more holes in a row to each other according to a longitudinal direction of the adjacent segment.

Alternatively, said fasteners in segment positions may also be separate elements provided with engagement terminals each of which cooperates with a corresponding engagement seat in a corresponding segment.

Advantageously, the embodiment which implements the features just described makes it possible to obtain a device of variable width which can be more easily adapted to plant stems of different cross-sections, which can be arranged at arbitrarily chosen radial distances from the stem, and which can facilitate positioning around the plant by temporarily diverting the circular sectors which comprise the channel body 1.

The invention claimed is:

1. A device for irrigating plants comprising:
a channel element of annular shape shaped as a ring and interrupted or interruptible at a point of the ring to define two ring ends, the two ring ends being spaced or spaceable apart to define an opening of the ring in a circumferential direction, and one of the two ring ends of the channel element at the opening having an extension in a direction that is radially external to an annular plane of the channel element; and
a tubular element inserted or insertable in a channel of the channel element, the tubular element being provided with a plurality of openings to enable a dripping of a liquid when the liquid is injected at one end of the tubular element, an opposite end of the tubular element being closed or closable with a plug or connectable to a liquid inlet end with of a three-way connector.

2. The device according to claim 1,
wherein the channel element is open at at least one of the end sides at the two ring ends,
further comprising one or more oscillating elements for closing at least one of the two ring ends and/or at least one or more limited segments of an open side of the channel element,
wherein the one or more oscillating elements are connected to a side of one of two walls laterally delimiting the channel element or are connected to a back wall of the channel element with a hinge and are swinging towards a wall of the channel element opposite to a wall of the hinge, and
wherein ends of the oscillating elements opposite to the hinge and a co-operating wall of the channel element are provided with co-operating members of mutual attachment so that each oscillating element can be brought into an open position of a corresponding opening of the channel element and alternatively into a closed position of the corresponding opening, from which the oscillating element is optionally detachable.

3. The device according to claim 1, wherein one end of the channel element is shaped as a counter-curve defining a guiding section having a concavity different from a concavity of a remainder of the channel element'

4. The device according to claim 1, wherein, when inserted into the channel element, the tubular element is positioned with the closed or closable end at an end of the channel element.

5. The device according to claim 1, wherein one end of the channel element comprises a closing cap elastically constrained to a body of the channel element so as to be swingable and positioned to close the tubular element.

6. The device according to claim 5, wherein said closing cap is mounted on the oscillating element of the end of the channel element at a position, on a face of the oscillating element, facing an inside of the channel element.

7. The device according to claim 3, wherein the guiding section comprises an overrun appendix to guide the tubular element along a path in a plane not parallel to the annular plane of the channel element.

8. The device according to claim 1, wherein the channel element in open configuration is made by joining two or more circular segments reciprocally constrained in swing zones present at ends of the two or more circular segments so as to enable a reciprocal swing within a single geometrical plane.

9. The device according to claim 8, wherein the swing of the two or more circular segments enables a reciprocal arrangement of the two or more segments so that the two ends of the channel element are adjacent to each other when the device is positioned in a closed working condition and the two ends of the tubular element are connected with a connecting member.

10. The device according to claim 3, wherein a free end of the guiding section of the channel element has a vertical engagement element for connection between the tubular element and a feed tube of the device, the vertical engagement element being elastically constrained to a body of the channel element so that the body of the channel element is rotatable and engaged in the tubular element.

11. The device according to claim 10, wherein the vertical engagement element is monolithic or connected to the channel element.

12. The device according to claim 1, wherein the channel element has a plurality of support elements of the tubular element, the support elements comprising removable channel closure elements to define and delimit at least one closed section of the channel element within which a corresponding portion of the tubular element is enclosed.

13. The device according to claim 12, wherein the support elements for the tubular element are mutually independent and connected to an edge of the channel element to be engageable and disengageable with an opposite edge of the channel element so as to form independent removable channel closure elements.

14. The device according to claim 12, wherein the channel element has a back wall and two U-shaped side walls, the supporting elements for the tubular element comprising L-shaped fins monolithic with the channel element and shaped as an extension of a side wall, an opposite side wall having corresponding coupling extensions for elements acting as hooks to retain the L-shaped fins in a closed position of a channel defined by the channel element when each L-shaped fin is brought into contact with a corresponding coupling extension.

15. The device according to claim 14, further comprising support feet for insertion into a soil to be irrigated to hold the device firmly in position.

16. The device according to claim 15, wherein the support feet comprise conical or truncated conical protuberances removably attachable to the channel element.

17. The device according to claim 15, wherein the support feet are constrained to, or monolithic with, the support elements of the tubular element.

18. The device according to claim 15, wherein the support feet protrude from a wall opposite the L-shaped fins adapted for closing the channel so that, when a free part of the L-shaped fins is brought to engage on an edge of the channel element, the support feet are arranged to be perpendicular to the channel element.

19. The device according to claim 14, wherein the channel element has openings on the back wall of the channel element.

20. The device according to claim 19, wherein the openings are provided in correspondence of the L-shaped fins closing the channel element.
